(19) United States
(12) Patent Application Publication
(10) Pub. No.: US 2017/0004641 A1
(43) Pub. Date: Jan. 5, 2017

(54) DISPLAY CONTROL DEVICE, DISPLAY CONTROL METHOD, AND COMPUTER-READABLE MEDIUM FOR DISPLAY CONTROL

(71) Applicant: MITSUBISHI ELECTRIC CORPORATION, Tokyo (JP)

(72) Inventors: Shuhei OTA, Tokyo (JP); Taro KUMAGAI, Tokyo (JP)

(73) Assignee: Mitsubishi Electric Corporation, Tokyo (JP)

(21) Appl. No.: 15/125,756

(22) PCT Filed: Apr. 14, 2014
(86) PCT No.: PCT/JP2014/060606

§ 371 Date: Sep. 13, 2016

(51) Int. Cl. G06T 11/60; B60R 1/00

(52) U.S. Cl. CPC G06T 11/60; B60R 1/00; B60R 2300/205

(57) ABSTRACT

According to a display control device of this invention, various notification information is classified into a plurality of predetermined patterns of display modes in accordance with values of at least two parameters out of three parameters of the relation with driving, importance for the user, and immediacy of display, and displaying on a display device in the classified display mode. As a result, it is possible to notify information to a user at an appropriate timing with easily and intuitively understandable contents for the user without interrupting driving by the user.

### TECHNICAL FIELD

The present invention relates to a display control device, a display control method, and a display control program to instruct to display various information on a display device mounted on a moving body such as a vehicle.

### BACKGROUND ART

Conventionally, methods to provide information to a driver have been proposed in which various information of the inside and outside of the vehicle is displayed on a display device mounted on the vehicle without interrupting the driving of the vehicle.

For example, Patent Document 1 discloses a device to facilitate recognition by a user when vehicle information such as the vehicle speed or fuel consumption is displayed by changing a display format of the vehicle information such as displaying with enlarged numerals or icon in accordance with the vehicle speed or steering angle.

Further, Patent Document 2 discloses a device to enable recognition of contents of information with the peripheral vision of a driver by displaying an icon with a color different for each content of the information when vehicle information, operation apparatus icon, or traffic information is displayed.

On the other hand, with development of information communication techniques, it has been enabled to present various information such as navigation information or information on the Web to the driver of a vehicle. Upon presenting information to a driver, not to mention ensuring safety, it is desirable to present information necessary for the driver in an easily understandable manner and at a safe timing, because the time for paying attention to the information is limited.

### CITATION LIST

### Patent Documents

Patent Document 1: JP 2006-184222 A

Patent Document 2: JP 2010-234876 A

### SUMMARY OF INVENTION

### Problems to be Solved by the Invention

However, in the conventional techniques as illustrated in Patent Documents 1 and 2 for example, display is performed in an easily understandable manner for a driver by merely displaying information with an icon or changing the color of the icon in accordance with what information is displayed or the display contents of the information, and no consideration is made as to whether the driver should concentrate on driving or not, whether the information is important for the driver or not, or whether the information should be displayed immediately or not. Therefore, there is a problem that information necessary for a driver is not presented in an easily understandable manner at a safe timing.

This invention has been devised in order to solve the above problem, and an object of the invention is to provide a display control device, a display control method, and a display control program capable of presenting information necessary for a driver, when various information of the inside and outside of a moving body such as a vehicle is displayed on a display device mounted on the vehicle, in an easily understandable manner at a safe timing considering the relation with driving, importance for the user, and immediacy of display.

### Means for Solving the Problems

In order to achieve the above object, according to this invention, a display control device to instruct to display various information on a display device mounted on a moving body includes an information acquirer to acquire information of at least one of an inside of the moving body and an outside of the moving body, an information analyzer to analyze the information acquired by the information acquirer to acquire notification information to be notified to a user and a state of the moving body; an information storage to store at least two parameter values, out of three parameters of relation between the notification information and driving of the moving body, importance of the notification information for the user, and immediacy of the display of the notification information, and an image, which are associated with a type of the notification information, a display determinator to acquire, from the information storage, the at least two parameter values and the image corresponding to the type of the notification information acquired by the information analyzer and to determine a display mode including display information, a display timing, and a display position of the notification information based on the acquired at least two parameter values and the image, a display information generator to generate a display item to be displayed on the display device based on the display information of the display mode determined by the display determinator, and a display instructor to instruct to the display device to display the display item generated by the display information generator in accordance with the display mode determined by the display determinator.

### Effect of the Invention

In this invention, various notification information is classified into a plurality of predetermined patterns of display modes correspondingly to at least two parameter values out of three parameters of the relation with driving (D), importance for a user (I), and immediacy of display (T) and is displayed on a display device in the classified display mode. As a result, it is possible to notify information to the user at an appropriate timing with intuitive and easily understandable contents for the user without interrupting driving by the user.

### BRIEF DESCRIPTION OF DRAWINGS

FIG. 1 is a block diagram illustrating an example of a display control device according to a first embodiment and peripheral devices connected thereto;

FIG. 2 is a correspondence table illustrating an example of notification information types, parameters for determining a display mode of the notification information, and image data;

FIG. 3 shows explanatory diagrams illustrating exemplary backgrounds and frames of images or the like;

FIG. 4 is a correspondence table illustrating an example of combinations of “relevant/not relevant” of the respective parameters, classification of patterns, and display modes associated with each of the patterns;

FIG. 5 is an example of the table defining display timing for each notification information type when the display timing is “depending on the notification information type”;

FIG. 6 is a flowchart illustrating operations of the display control device according to the first embodiment;

FIG. 7 is a table illustrating a specific example of notification information types (N) analyzed by an information analysis unit, additional information of the notification information, and display mode patterns corresponding thereto;

FIG. 8 shows diagrams illustrating examples of display items generated by a display information generation unit;

FIG. 9 shows explanatory diagrams illustrating examples of displays where a generated display item is displayed on a display device;

FIG. 10 shows exemplary tables defining determination items using adjustment information acquired by an information analysis unit and adjustment values of each of the parameters corresponding to the determination items in a second embodiment;

FIG. 11 is a flowchart illustrating operations of a display control device according to the second embodiment;

FIG. 12 shows diagrams illustrating examples of display items generated by a display information generation unit of the second embodiment;

FIG. 13 shows explanatory diagrams illustrating examples of displays where generated display items and display positions are changed as a result of adjustment of the second embodiment;

FIG. 14 is a table illustrating a classification result, after performing adjustment according to the second embodiment, of the specific example (FIG. 7) of notification information types (N) analyzed by the information analysis unit, additional information of the notification information, and display mode patterns corresponding thereto;

FIG. 15 is an exemplary table defining display timing for each notification information type when the display timing is “depending on the notification information type”, further considering display timing determination information in a third embodiment; and

FIG. 16 is a flowchart illustrating operations of a display control device according to the third embodiment.

### MODES FOR CARRYING OUT THE INVENTION

Hereinafter, some embodiments of this invention will be described in detail with reference to the drawings.

An object of this invention is to display information acquired from the inside and outside of a vehicle for providing an intuitive understanding to a user without interrupting driving. Note that, in embodiments below, a display control device of this invention may be incorporated in a device mounted on a moving body such as a vehicle or applied to a server. The display control device may also be applied to an application or the like installed in mobile information terminals such as smartphones, tablet PCs, and cellular phones.

### First Embodiment

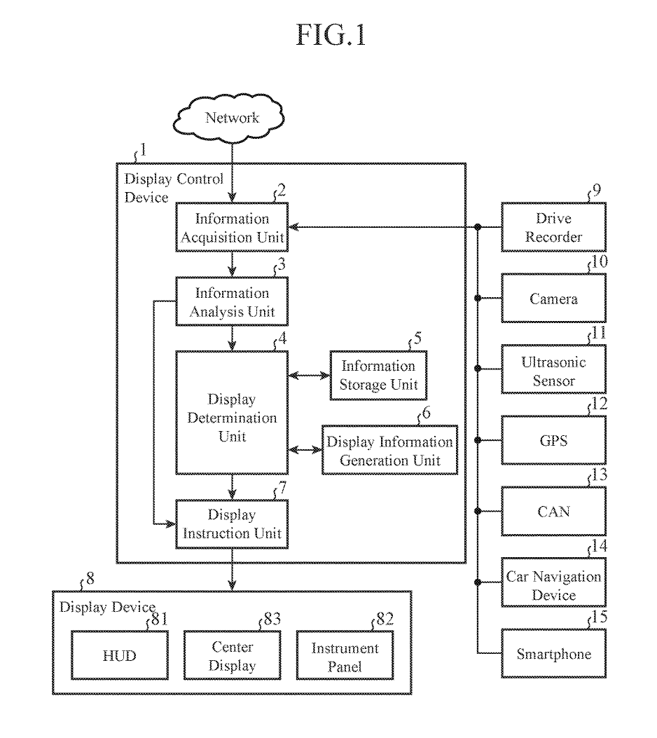

FIG. 1 is a block diagram illustrating an example of a display control device according to a first embodiment of this invention and peripheral devices connected thereto. A display control device 1 includes an information acquisition unit 2, an information analysis unit 3, a display determination unit 4, an information storage unit 5, a display information generation unit 6, and a display instruction unit 7. Although not illustrated, the display control device 1 further includes a communication unit to communicate with a network.

Further, the display control device 1 is connected with a display device 8, a drive recorder 9, a camera 10, an ultrasonic sensor 11, a global positioning system (GPS) 12, a controller area network (CAN) 13, a car navigation device 14, and a smartphone 15.

Note that, the first embodiment will be described assuming that the aforementioned devices are mounted on a vehicle (moving body) such as an automobile.

The display device 8 is, for example, a head-up display (HUD) 81, an instrument panel (IP) 82, or another separate display or the like (center display 83) to display information output from a device such as the car navigation device 14 or the smartphone 15. The display device 8 displays information in accordance with an instruction from the display control device 1.

The display control device 1 analyzes information of the inside of the vehicle (inside the moving body) or outside of the vehicle (outside the moving body) to acquire information to be notified to a user (passenger) (hereinafter referred to as “notification information”), generates a display item corresponding to the notification information based on the relation with driving, importance for the user, and immediacy of display, and instructs, to the predetermined display device 8, to display the generated display item at a predetermined timing.

Generation of display information, determination of a display position, and determination processing of timing to display the display item will be described later.

Next, each component of the display control device 1 will be described.

The information acquisition unit 2 acquires information of at least one of the inside of the vehicle (inside the moving body) or outside of the vehicle (outside the moving body) via the Internet or by any of the drive recorder 9, the camera 10, the ultrasonic sensor 11, the GPS 12, the CAN 13, the car navigation device 14, and the smartphone 15.

The information analysis unit 3 analyzes the information acquired by the information acquisition unit 2 to acquire the notification information to be notified to the user or of a state of the vehicle (moving body).

Here, the notification information is, for example, SNS-related information such as e-mails, posting information or the like on social network service (SNS) (hereinafter referred to as “SNS-related information”), sudden acceleration alert information, fuel shortage alert information, unsteady driving alert information, driving score information, event information, and incoming call information.

This notification information includes at least a notification information type (N) representing a type of the information and may further include additional information depending on the notification information type (N).

The additional information provides an explanation of the contents of the notification information in detail and includes, for example when the notification information is the “SNS-related information”, the body part of an e-mail, the sender information, posted contents and information of the poster or the like on the SNS. When the notification information is “event information”, the additional information includes the date, contents, place, or the like of the event. When the notification information is “incoming call information”, the additional information includes the name or the number of the caller, or the like.

Further, the state of a vehicle (moving body) includes, for example, the speed of the vehicle (moving body), steering angle, whether there is an approaching vehicle or not, present location, travelling direction of the vehicle (moving body), and destination. These are determined by using, for example, an image of the outside of the vehicle (outside the moving body), image of the inside of the vehicle (inside the moving body), GPS information, CAN information, navigation information, or the like.

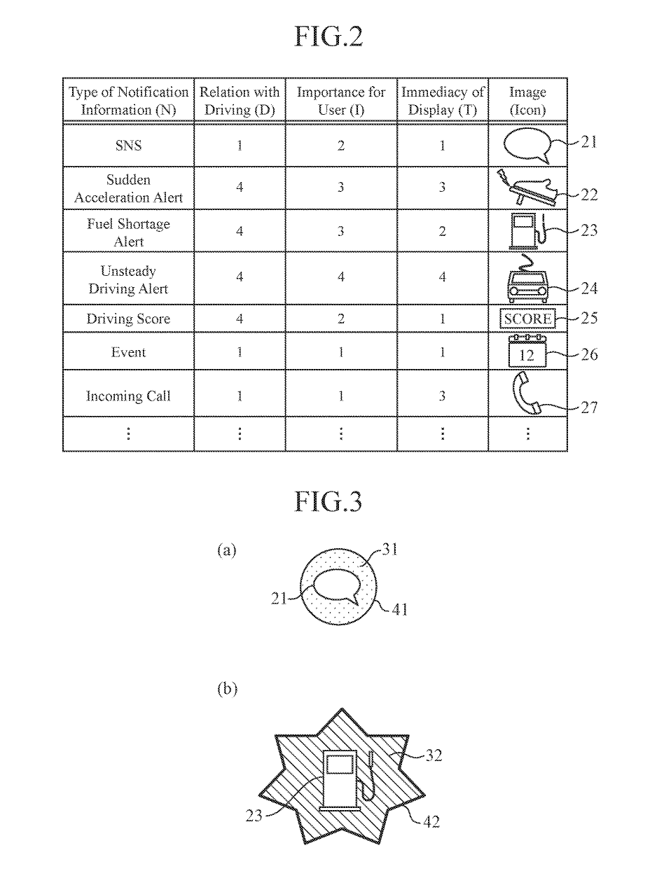

The information storage unit 5 stores the notification information type (N), parameters for determining the display mode of the notification information, and image data associated with the notification information type (N), for example as illustrated in FIG. 2.

FIG. 2 is a correspondence table illustrating an example of notification information types, parameters for determining the display mode of the notification information, and image data.

Here, the parameters for determining the display mode of the notification information (hereinafter simply referred to as “parameter”) are the relation between the notification information and driving (D) (hereinafter referred to as the “relation (D)”), the importance of the notification information for the user (I) (hereinafter referred to as the “importance (I)”), and the immediacy of display of the notification information (T) (hereinafter referred to as the “immediacy (T)”).

The relation (D) is a degree how much the notification information is related to driving. The importance (I) is a degree how important the notification information is for the user driving the vehicle (moving body). The immediacy (T) is a degree how urgent the notification information is to be notified to the user. Note that, here, each of the relation (D), importance (I), and immediacy (T) is indicated by a value from 1 to 4, wherein “1” represents not relevant (substantially not relevant), “2” represents rather closer to not relevant, “3” represents rather closer to relevant, and “4” represents relevant (extremely relevant).

Specifically, as illustrated in FIG. 2, for example the notification information type (N) of “SNS” is stored in association with the relation (D) of “1” since no relation with driving is assumed, the importance (I) of “2” since the contents of an e-mail may not always be important for the user, and the immediacy (T) of “1” since the contents are not always required to be immediately notified. Further, a balloon icon 21 is stored as the image (icon).

The notification information type (N) of “sudden acceleration alert” is stored in association with the relation (D) of “4” since it is related to acceleration of the vehicle (moving body), and the importance (I) and immediacy (T) of “3” since it may result in an accident. Further, a sudden acceleration icon 22 is stored as the image (icon).

The notification information type (N) of “fuel shortage alert” is stored in association with the relation (D) of “4” since it is related to the fuel of the vehicle (moving body), the importance (I) of “3” since the vehicle (moving body) may stop, and the immediacy (T) of “2” since the vehicle (moving body) does not immediately stop. Further, a refueling icon 23 is stored as the image (icon).

The notification information type (N) of “unsteady driving alert” is stored in association with the relation (D) of “4” since it is related to behavior of the vehicle (moving body), and the importance (I) and immediacy (T) of “4” since there is a high possibility of resulting in an accident. Further, an unsteady driving icon 24 is stored as the image (icon).

The notification information type (N) of “driving score” is stored in association with the relation (D) of “4” since it is related to a driving score, the importance (I) of “2” since the information may not always be important for the user, and the immediacy (T) of “1” since it is sufficient to present the driving score after finishing driving. Further, a score icon 25 is stored as the image (icon).

The notification information type (N) of “event” is stored in association with the relation (D) of “1” since it is assumed not related to driving, and the importance (I) and immediacy (T) of “1” since the event may not always be interesting to the user. Further, an event calendar icon 26 is stored as the image (icon).

The notification information type (N) of “incoming call” is stored in association with the relation (D) of “1” since it is assumed as not related to driving, the importance (I) of “1” since the call may not always include important contents or from an important person for the user, and the immediacy (T) of “3” since hands-free conversation is enabled. Further, a telephone icon 27 is stored as the image (icon).

Note that, the values of respective parameters or the image corresponding to each of the notification information types (N) are not limited to the values or image (icon) illustrated in FIG. 2. Further, the information storage unit 5 may be designed to store only two parameters out of the aforementioned three parameters.

Further, the minimum value and maximum value for each parameter are set at 1 and 4, respectively, in this embodiment; however, the values are not limited thereto. Moreover, the maximum value or the minimum value may differ for each parameter.

The display determination unit 4 acquires, from the information storage unit 5, the respective parameter values and image (icon) corresponding to the notification information type (N) acquired by the information analysis unit 3 and determines the display mode of each notification information based on the respective parameter values and image (icon).

Here, the display mode includes the display information, display timing, and display position.

The display information includes the contents of the images (icons), additional information, or the like (hereinafter referred to as the “images or the like”), the amount of additional information, the shape of background images of the images or the like (hereinafter referred to as the “background”), the color of the background, the existence or absence of a frame of the background, size or the like, and whether the image or the like flashes or not. Here, the amount and size of additional information will be described later.

FIG. 3 shows explanatory diagrams illustrating examples of backgrounds and frames of images or the like. FIG. 3(a) illustrates the balloon icon 21 with a blue background 31 encircled in a small round frame 41 when the notification information type (N) is SNS. Further, FIG. 3(b) illustrates the refueling icon 23 with a red background 32 encircled in a big star-shaped frame 42 when the notification information type (N) is the fuel shortage alert.

Moreover, the display timing shows conditions for displaying, on the display device 8, the display item generated by the display information generation unit 6 based on the display information.

The display position specifies the display device 8 that is a displaying object to display the display item. That is, in this embodiment, any one of the HUD 81, the instrument panel 82, and the center display 83 is specified for display. Here, not only specifying the display device but also the display position on the display device may be included.

Next, a method to determine the display mode of the notification information by the display determination unit 4 based on the respective parameter values will be described.

First, the display determination unit 4 determines whether the value of each parameter acquired from the information storage unit 5 is less than or equal to a preset predetermined threshold value or not. If the value is less than or equal to the predetermined threshold value, determination of “not relevant” is made and if the value is larger than the predetermined threshold value, determination of “relevant” is made.

In this embodiment, as described above, each of the parameters of relation (D), importance (I), and immediacy (T) is represented by a value from 1 to 4 with “1” representing not relevant (substantially not relevant), “2” representing rather closer to not relevant, “3” representing rather closer to relevant, and “4” representing relevant (extremely relevant). Therefore, a predetermined threshold value of “2.5”, for example, may be preset for all of the parameters.

As a result, for the relation with driving (D), the display determination unit 4 determines as “not relevant to relation” for a value of 2.5 or less, or as “relevant to relation” for a value larger than 2.5. Similarly, for the importance for the user (I) and immediacy of display (T), determination of “relevant/not relevant to importance” and “relevant/not relevant to immediacy” is made.

Thereafter, a display mode pattern is determined based on the combination of “relevant/not relevant to relation”, “relevant/not relevant to importance”, and “relevant/not relevant to immediacy” of the respective parameters. Then, a background, display position, or the like associated with the determined pattern are determined as the display mode of the notification information.

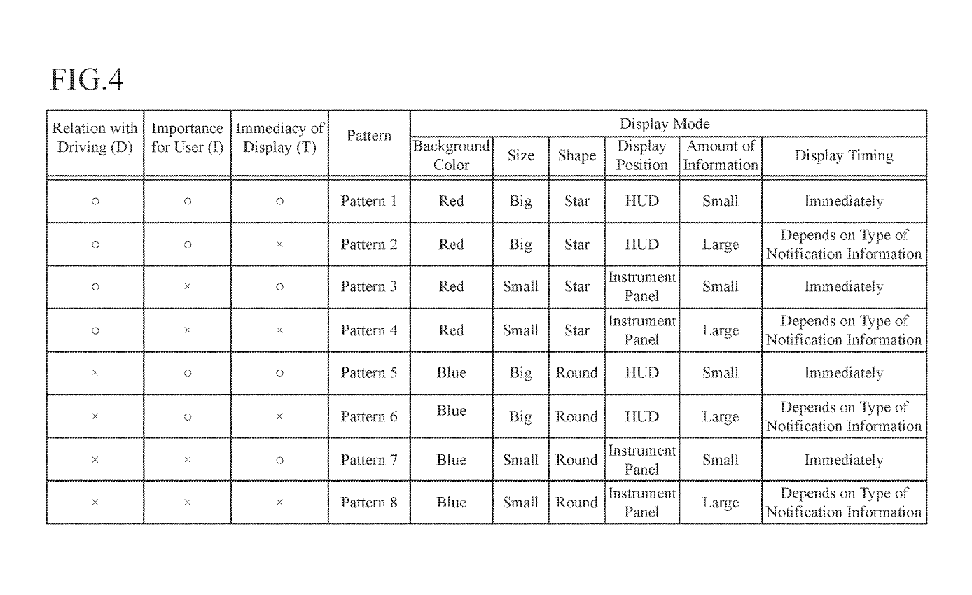

FIG. 4 is a table illustrating an example of combinations of “relevant/not relevant” of the respective parameters, classification of patterns, and display modes associated with each of the patterns.

In FIG. 4, “relevant” and “not relevant” for the respective parameters are represented with “o” and “x”, respectively.

In a case relevant to driving, the background color and shape are defined to support the intuitive determination by the user.

For example, in a case not relevant to the relation (D) (in the case of x), the background color is “blue” and the shape of the background frame is “round”. On the other hand, in a case relevant to the relation (D) (in the case of ∘), the background color is defined as “red” and the shape of the background frame is defined as “star” to attract attention.

In a case relevant to importance for the user (I), the size or display position of the display item is defined such that the user can immediately respond.

For example, in a case not relevant to importance (I) (in the case of x), the size of the display item is “small” and the display position is “instrument panel”. On the other hand, in a case relevant to importance (I) (in the case of ∘), the size of the display item is defined as “big” and the display position is defined as “HUD” that is easily recognized.

Further, in a case relevant to immediacy of display (T), the amount of information and display timing is defined such that the user can immediately recognize the information.

For example, in a case not relevant to immediacy (T) (in the case of x), the amount of information is “large” and the display timing is “depending on the notification information type”. On the other hand, in a case relevant to immediacy (T) (in the case of ∘), the amount of information is defined as “small” and the display timing is defined as “immediately”.

In this manner, by generating the display item by synthesizing the display materials corresponding to each of the relation with driving (D), importance for the user (I), and immediacy of display (T), a user can intuitively understand what contents are included in the display information and what to pay attention to.

Moreover, the amount of the display information is indicated by the display material corresponding to the immediacy of display (T) so that the information amount varies based on the immediacy. Therefore, the user can immediately and intuitively understand the contents of the information.

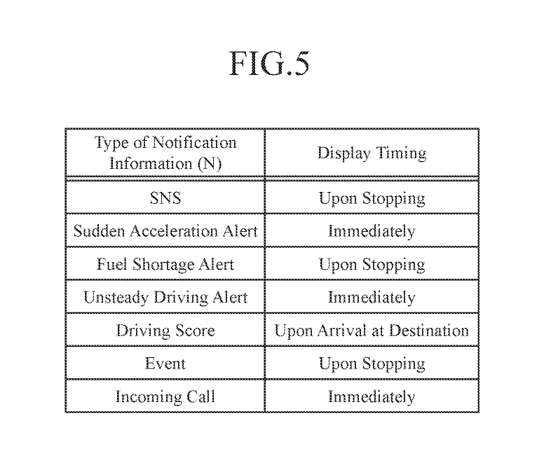

Here, the display timing will be described in a case where it is “depending on the notification information type”. FIG. 5 is an example of a table defining display timing for each notification information type in a case where the display timing is “depending on the notification information type”.

That is, the display determination unit 4 also retains data in a table as illustrated in FIG. 5, for example, along with the data in the table as illustrated in FIG. 4.

Here, for example, as illustrated in FIG. 5, “upon stopping” is defined for the notification information types (N) of “SNS”, “fuel shortage alert”, and “event” while “upon arrival at a destination” is defined for the notification information type (N) of “driving score”. Also, “immediately” is defined for the notification information types (N) of “sudden acceleration alert”, “unsteady driving alert”, and “incoming call” and thus the display timing is always “immediately” regardless of the parameter value for the immediacy (T).

Note that, in the first embodiment, it is assumed that the display mode of the notification information is determined based on the three parameters. However, the determination is not limited thereto and may be made based on, for example, only two parameters.

Furthermore, though the threshold value for determining “relevant/not relevant” for each parameter is set at “2.5”, the threshold value is not limited thereto.

The display information generation unit 6 generates a display item to be displayed on the display device 8 based on the display information of the display mode determined by the display determination unit 4.

Specifically, processed additional information and a determined image are combined based on the background image of determined shape and color and the value of the amount of determined additional information. Then, the display item with a size corresponding to the determined size of display item is generated.

Here, the setting value for the amount of additional information and processing of additional information will be described.

For example, when the notification information type (N) is “SNS” and setting values for the amount of information are defined as two steps of “0” (amount of information: small) and “1” (amount of information: large) while additional information includes the sender of the e-mail, title, and body, the additional information is processed to include only the sender of the e-mail and title for the amount of information of “1”, while the additional information is processed to include only the sender of the e-mail for the amount of information of “0”, thereby reducing the amount of information. Here, the setting values for the amount of information may be more than two steps.

Alternatively, the additional information may be defined as included/not included instead of increasing or reducing the amount of additional information according to the setting value.

In this first embodiment, the explanation is given by assumed that the additional information includes only the sender of the e-mail for the amount of information of “1” while no additional information is included (not displayed) for the amount of information of “0”. Note that, the same is also assumed for other embodiments explained below.

The display instruction unit 7 acquires the state of the vehicle (moving body) from the information analysis unit 3 and determines whether the state of the vehicle (moving body) satisfies conditions of display timing of the display mode determined by the display determination unit 4 or not. When the conditions are satisfied, the display instruction unit 7 then outputs the instruction to the display device 8 to display the display item generated by the display information generation unit 6 at the display position determined by the display determination unit 4.

This allows for notification of information at a timing not interrupting the driving by the user.

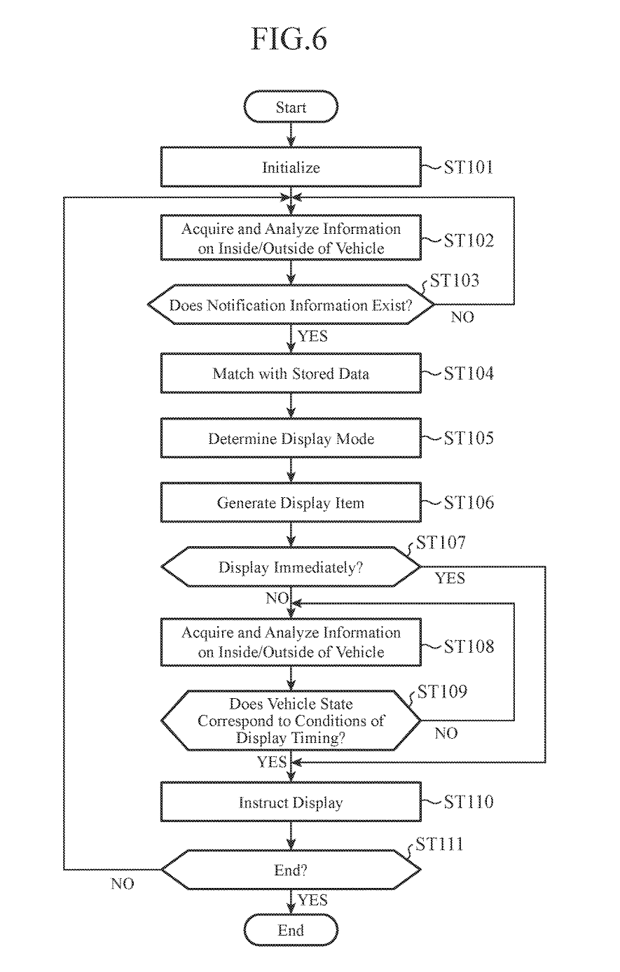

Next, operations of the display control device 1 of the first embodiment will be described using the flowchart shown in FIG. 6.

First, the display control device 1 performs initialization of the entire device when the engine is turned on or a function of the display control device 1 is turned on (step ST101).

Next, the information acquisition unit 2 acquires information of at least one of the inside of the vehicle (inside the moving body) or outside of the vehicle (outside the moving body) via the Internet or from a drive recorder 9, a camera 10, an ultrasonic sensor 11, a GPS 12, a CAN 13, a car navigation device 14, a smartphone 15, or the like. Thereafter, the information analysis unit 3 analyzes the information acquired by the information acquisition unit 2 to acquire notification information, the state of the vehicle (moving body), or the like (step ST102).

When the notification information cannot be acquired (NO in step ST103), the flow returns to processing in step ST102. On the other hand, when the notification information can be acquired (YES in step ST103), the display determination unit 4 performs matching with the data stored in the information storage unit 5 to acquire, from the information storage unit 5, the value of each parameter and image corresponding to the notification information type (N) acquired by the information analysis unit 3 (step ST104), and determines the display mode of the notification information based on the respective parameter values and image (step ST105).

Thereafter, the display information generation unit 6 generates a display item based on the display information determined by the display determination unit 4 (step ST106).

The display instruction unit 7 then determines whether the display timing determined by the display determination unit 4 is “immediately” or not (step ST107).

Here, when the display timing is not “immediately” (NO in step ST107), similarly to step ST102, the information acquisition unit 2 acquires information of at least one of the inside of the vehicle (inside the moving body) and the outside of the vehicle (outside the moving body), and the information analysis unit 3 analyzes the information acquired by the information acquisition unit 2 to acquire the notification information, state of the vehicle (moving body), or the like (step ST108).

The display instruction unit 7 then acquires the state of the vehicle (moving body) from the information analysis unit 3 and determines whether the state of the vehicle (moving body) satisfies conditions of display timing determined by the display determination unit 4 or not (step ST109).

When it is determined that the state of the vehicle (moving body) does not satisfy the conditions of display timing (NO in step ST109), processing in step ST108 and on is repeated. On the other hand, when it is determined that the state of the vehicle (moving body) satisfies the conditions of display timing (YES in step ST109), the display instruction unit 7 outputs an instruction to the display device 8 determined by the display determination unit 4 to display the display item generated by the display information generation unit 6 (step ST110).

Further, when the display timing determined by the display determination unit 4 in the determination in step ST107 is “immediately” (YES in step ST107), the processing in steps ST108 and ST109 is not performed and the display instruction unit 7 outputs instruction to the display device 8 determined by the display determination unit 4 to display the display item generated by the display information generation unit 6 (step ST110).

Unless the engine is turned off or the user turns off the function of the display control device 1 (NO in step ST111), the processing in step ST102 and on is repeated. In other cases (YES in step ST111), the processing is terminated.

Here, the display device 8 displays the instructed display item at an instructed position upon receiving an instruction from the display instruction unit 7 in the processing in step ST110.

The above processing described with a flowchart will be described with a specific example below.

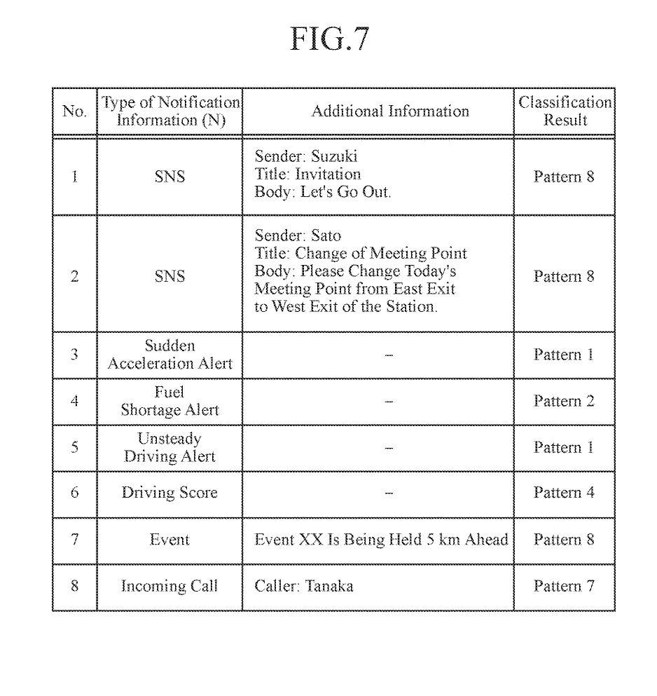

FIG. 7 is a table illustrating a specific example of notification information types (N) and additional information of the notification information which are analyzed by the information analysis unit 3, and display mode patterns corresponding thereto. In FIG. 7, eight kinds of specific examples are illustrated, and descriptions are given on the specific example of No. 1. Note that additional information denoted with “-” in FIG. 7 represents that there is no additional information.

As illustrated by No. 1 in FIG. 7, for example an e-mail where the sender is “Suzuki”, the title is “Invitation”, and the body is “Let's go out.” is received, the processing in steps ST101 to ST103 is performed. As a result, the information analysis unit 3 analyzes that the notification information has the notification information type (N) of “SNS” and includes additional information of sender “Suzuki”, title “Invitation”, and body “Let's go out.”

Further, here, the information storage unit 5 stores the data illustrated in FIG. 2, and the display determination unit 4 retains the data illustrated in FIGS. 4 and 5. Moreover, the threshold value for determining “relevant/not relevant” for each parameter is set at “2.5”.

The display determination unit 4 refers to the data stored in the information storage unit 5 as illustrated in FIG. 2 and acquires, as parameters corresponding to the notification information type (N) of “SNS”, the value of “1” for the relation with driving (D), value of “2” for the importance for the user (I), value of “1” for the immediacy of display (T), and the balloon icon 21 (step ST104).

Next, the display determination unit 4 determines the relation (D) as “not relevant” (x), the importance (I) as “not relevant” (x), and the immediacy (T) as “not relevant” (x), refers to the table illustrated in FIG. 4, and determines the display mode pattern as pattern 8. Furthermore, since the display timing is “depending on the notification information type”, the display timing is determined as “upon stopping” according to the table illustrated in FIG. 5 as described earlier (step ST105).

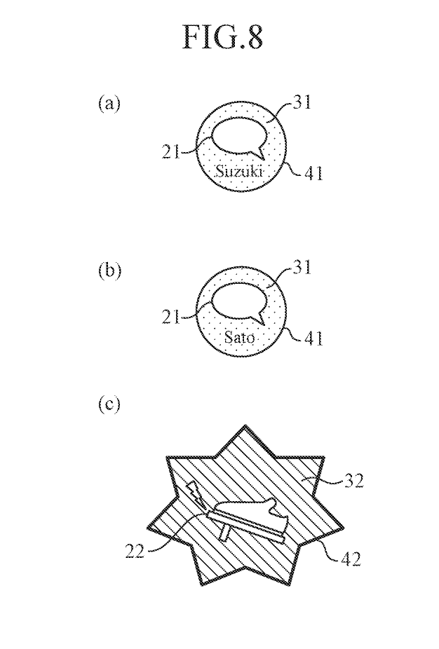

Thereafter, the display information generation unit 6 generates a display item based on the display information of the display mode determined by the display determination unit 4 (step ST106). That is, according to the display mode of pattern 8 with a display item of an image having the background color of “blue”, size “small”, and shape “round” with the amount of information of “large” and thus having only the sender “Suzuki” as the contents of the e-mail for additional information, the display item is generated as illustrated in FIG. 8(a) where the background 31 is blue encircled in the small round frame 41 in which the balloon icon 21 and the sender “Suzuki” are combined.

FIG. 8 shows diagrams illustrating examples of display items generated by the display information generation unit 6.

Here, since the display timing in this case is not “immediately” (NO in step ST107), the information analysis unit 3 analyzes the information of the inside/outside of the vehicle acquired by the information acquisition unit 2 (step ST108) and the display instruction unit 7 acquires the state of the vehicle (moving body) from the information analysis unit 3 and determines whether the vehicle (moving body) is in the state of “upon stopping” that is the display timing or not (step ST109).

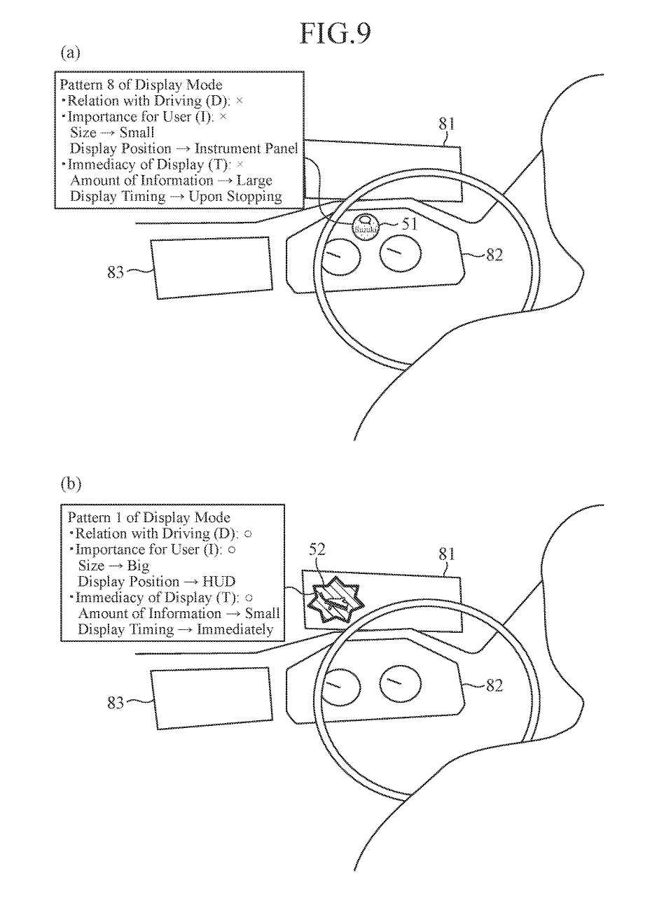

When the vehicle is in the state of “upon stopping” (YES in step ST109), the display instruction unit 7 instructs to display the display item generated by the display information generation unit 6 as illustrated in FIG. 8(a) on the “instrument panel” (instrument panel 82) that is the display position determined by the display determination unit 4 (step ST110). As a result, for example as illustrated in FIG. 9(a), the display item 51 is displayed on the instrument panel 82.

FIG. 9 shows explanatory diagrams illustrating examples of display where the generated display item is displayed on the display device 8 (any one of the HUD 81, the instrument panel 82, and the center display 83).

Similarly, as illustrated by No. 2 in FIG. 7, for example, when an e-mail having the sender “Sato”, title “Change of meeting point”, and body “Please change today's meeting point from east exit to west exit of the station.” is received, the notification information type (N) is “SNS” with the display mode pattern of pattern 8 and thus the display item is as illustrated in FIG. 8(b). In addition, the display timing is “upon stopping” with the display position of “instrument panel” (instrument panel 82).

Furthermore as illustrated by No. 3 in FIG. 7, for example when the notification information type (N) is “sudden acceleration alert” with no additional information, the display mode pattern is pattern 1 with the display item of the image having the background color of “red”, size “big”, and shape “star”, that is, the display item is as illustrated in FIG. 8(c) where the background is the red background 32 encircled in the big star-shaped frame 42 in which the sudden acceleration icon 22 is combined. In addition, the display timing is “immediately” with the display position of “HUD” (HUD 81). As a result, for example as illustrated in FIG. 9(b), the display item 52 is displayed on the HUD 81.

Moreover, as illustrated by No. 4 to No. 8 in FIG. 7, classification is made into various display mode patterns based on the notification information type (N), for example, the display mode pattern of pattern 2 for the notification information type (N) of “fuel shortage alert” with no additional information, the display mode pattern of pattern 1 for the notification information type (N) of “unsteady driving alert” with no additional information, the display mode pattern of pattern 4 for the notification information type (N) of “driving score” with no additional information, the display mode pattern of pattern 8 for the notification information type (N) of “event” with additional information of “Event xx is being held 5 km ahead.”, and the display mode pattern of pattern 7 for the notification information type (N) of “incoming call” with additional information of “Caller: Tanaka”. Here, detailed descriptions on a specific example of the above are omitted.

In this manner, by performing classification into the predetermined plurality of display mode patterns for each of the notification information types (N) according to the relation with driving (D), importance for the user (I), and immediacy of display (T), it is possible to display various notification information classified into the predetermined plurality of patterns.

Note that, FIG. 7 illustrates exemplary classification into the predetermined plurality of display mode patterns for each of the notification information types (N) according to three parameters of the relation with driving (D), importance for the user (I), and immediacy of display (T); however, classification can be made into the predetermined plurality of display mode patterns in accordance with at least two parameters out of the three parameters.

As described above, in the first embodiment, various notification information is classified into a plurality of predetermined patterns of display modes according to values of at least two parameters out of three parameters of the relation with driving (D), importance for the user (I), and immediacy of display (T), and is displayed on a display device in the classified display mode. As a result, it is possible to notify information to a user at an appropriate timing with easily and intuitively understandable contents for the user without interrupting driving by the user.

Note that, the display control device 1 is implemented as a specific means where hardware and software cooperate to each other through execution of a program related to processing unique to this invention by a microcomputer in a device mounted on a moving body such as a vehicle to which the display control device 1 is applied to, a server connected thereto, a mobile information terminal, or the like. Such a configuration can be applied similarly to the other embodiments below.

### Second Embodiment

A block diagram illustrating an example of a display control device according to a second embodiment of this invention and peripheral devices connected thereto is the same as FIG. 1 illustrated in the first embodiment and thus illustration thereof and description thereon are omitted. The second embodiment illustrated below is different as compared to the first embodiment in the point that each of the parameters corresponding to the notification information type (N) is adjusted based on the information acquired by the information acquisition unit 2 or an analysis result thereof by the information analysis unit 3, and that a display mode of a display item is determined based on the respective adjusted parameter values.

The information analysis unit 3 analyzes the information acquired by the information acquisition unit 2 to acquire notification information. The information analysis unit 3 further acquires adjustment information for determining an adjustment value for each of the parameters corresponding to the notification information.

Here the descriptions are given assuming that the adjustment information includes a keyword (K), state of the vehicle (moving body) (C), and preference of the user (P) (hereinafter referred to as “preference (P)”); however, the adjustment information is not limited thereto.

The keyword (K) is a word or a group of words defined in advance for each of the notification information types (N) (hereinafter referred to as “words”).

The information analysis unit 3 performs morphological analysis on additional information included in the notification information and, if there is any adjustment information (keyword (K)), acquires the adjustment information.

The state of the vehicle (moving body) (C) includes, for example, the speed of the vehicle (moving body), steering angle, whether there is an approaching vehicle or not, present location, travelling direction of the vehicle (moving body), and destination similarly to those described in the first embodiment, and is determined by using, for example, an image of the outside of the vehicle (outside the moving body), an image of the inside of the vehicle (inside the moving body), GPS information, CAN information, route navigation information, or the like.

The preference (P) includes information such as setting values of a mounted device, places frequently visited by the user, or contacts that the user frequently calls or e-mails and is acquired by analyzing, for example, setting values, an operation history, or registered favorites of a device such as a car navigation device 14 or a smartphone 15. Here, information learned from the device such as the car navigation device 14 or the smartphone 15 may be used.

Next, adjustment information to be acquired that is defined for each of the notification information types (N) will be described.

For example, for the notification information type (N) of “SNS”, words such as “today”, “tomorrow”, “next week”, “change” are defined as the keyword (K). When additional information of the notification information includes any of these defined words, those words are acquired as the keyword (K).

Also, information of the vehicle speed, steering angle, and whether there is an approaching vehicle or not is acquired as the state of the vehicle (moving body) (C).

Moreover, when the name of the sender is registered as favorites, the name registered as favorites is acquired as the preference (P).

As another example, in a case where the notification information type (N) is “sudden acceleration alert”, only a setting value of the sudden acceleration alert notification (settings as important or unimportant) is acquired for the preference (P) while the keyword (K) and state of the vehicle (moving body) (C) are not acquired.

Note that, in the description below, adjustment information to be acquired is same as described above; however, the adjustment information to be acquired is not limited thereto.

The display determination unit 4 determines the adjustment value of each of the parameters corresponding to the notification information type (N) using the adjustment information acquired by the information analysis unit 3.

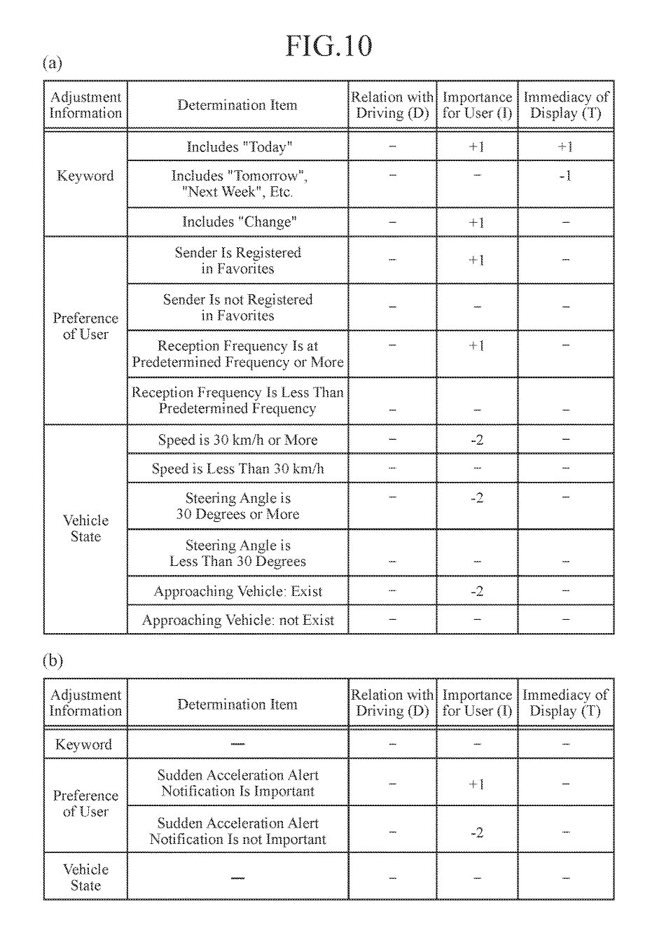

Specifically, in the display determination unit 4, as illustrated in FIG. 10 for example, determination items using adjustment information acquired by the information analysis unit 3 and adjustment values corresponding to the determination items are defined for each of the notification information types (N).

FIG. 10 shows an example of a table defining determination items using adjustment information acquired by the information analysis unit 3 and adjustment values of each of the parameters corresponding to the determination item.

FIG. 10(a) is an example for the notification information type (N) of “SNS” and FIG. 10(b) is another example for the notification information type (N) of “sudden acceleration alert”.

For example in the case of notification information type (N) of “SNS”, as illustrated in FIG. 10(a), for example when a word “today” is included in the result of morphological analysis with regard to the keyword (K), the adjustment value for each of the importance (I) and immediacy (T) is set at “+1”. Further, when the morphological analysis result includes words representing a date such as “tomorrow”, “next week”, or “next month” that is not most recent, the adjustment value for the immediacy (T) is set at “−1”. Moreover, when the morphological analysis result includes the word “change”, the adjustment value for the importance (I) is set at “+1”.

Furthermore with regard to the preference (P), when the name of the sender of an e-mail corresponds to information of persons registered as favorites, the adjustment value for the importance (I) is set at “+1”, or when the frequency of receiving e-mails from the sender is more than or equal to a predetermined frequency (e.g. a predetermined number of e-mails in a predetermined period of time such as five times a day or five times for every three days), the adjustment value for the importance (I) is set at “+1”.

Furthermore, with regard to the state of the vehicle (moving body) (C), when the speed is more than or equal to a predetermined speed (e.g. 30 km/h), the adjustment value for the importance (I) is set at “−2”, when the steering angle is more than or equal to a predetermined angle (e.g. 30 degrees), the adjustment value for the importance (I) is set at “−2”, or when there is an approaching vehicle, the adjustment value for the importance (I) is set at “−2”.

Also, for example in the case of notification information type (N) of “sudden acceleration alert”, as illustrated in FIG. 10(b), when the mode of sudden acceleration alert notification preset by the user with regard to preference (P) is “important”, the adjustment value for the importance (I) is set at “+1” and when the mode of sudden acceleration alert notification is set as “unimportant”, the adjustment value for the importance (I) is set at “−2”. Here, no adjustment value is set for the keyword (K) or state of the vehicle (moving body) (C).

Other than the above, parameter adjustment using adjustment information is not performed for the notification information types (N) of “fuel shortage alert”, “unsteady driving alert”, and “driving score” in this embodiment; however, needless to say, adjustment information may also be defined for these.

Moreover, for example for the notification information type (N) of “event”, with regard to the preference (P), if a name of an event included in the additional information is searched for a predetermined number of times or more by the car navigation device 14 or the smartphone 15, an adjustment value for the importance (I) is set at “+1” and otherwise no adjustment is performed.

Furthermore for example for the notification information type (N) of “incoming call”, with regard to the state of the vehicle (moving body) (C), similarly to the case of “SNS” illustrated in FIG. 10(a), when the speed is more than or equal to a predetermined speed (e.g. 30 km/h), the adjustment value for the importance (I) is set at “−2”, when the steering angle is more than or equal to a predetermined angle (e.g. 30 degrees), the adjustment value for the importance (I) is set at “−2”, and when there is an approaching vehicle, the adjustment value for the importance (I) is set at “−2”. Here, no adjustment value is set for the keyword (K) or preference (P).

Note that, the determination item for each of the notification information types (N) illustrated here and adjustment values for each of the parameters are not limited thereto but may be set and defined by a user as appropriate.

The display determination unit 4 adjusts each of the parameters acquired from the information storage unit 5 with the adjustment value defined as above and determines a display mode of the notification information based on the adjusted parameters.

It is assumed that the adjusted parameter value for the relation (D) is represented by D_{F}, the parameter value before adjustment is represented by D_{N}, and for the parameter value, the adjustment value by the keyword (K) is represented by D_{K}, the adjustment value by the state of the vehicle (moving body) (C) is represented by D_{C}, and the adjustment value by preference (P) is represented by D_{P}. Then, the adjusted parameter value D_{F} for the relation (D) is obtained by the following formula (1).

D_{F}=D_{N}+D_{K}+D_{C}+D_{P} (1)

Similarly, it is assumed that the adjusted parameter value for the importance (I) is represented by I_{F}, the parameter value before adjustment is represented by I_{N}, and for the parameter value, the adjustment value by the keyword (K) for the parameter value is represented by I_{K}, the adjustment value by the state of the vehicle (moving body) (C) is represented by I_{C}, and the adjustment value by preference (P) is represented by I_{P}. Then, the adjusted parameter value I_{F} for the importance (I) is obtained by the following formula (2).

I_{F}=I_{N}+I_{K}+I_{C}+I_{P} (2)

Furthermore, it is assumed that the adjusted parameter value for the immediacy (T) is represented by T_{F}, the parameter value before adjustment is represented by T_{N}, and for the parameter value, the adjustment value by the keyword (K) is represented by T_{K}, the adjustment value by the state of the vehicle (moving body) (C) is represented by T_{C}, and the adjustment value by preference (P) is represented by T_{P}. Then, the adjusted parameter value T_{F} for the immediacy (T) is obtained by the following formula (3).

T_{F}=T_{N}+T_{K}+T_{C}+T_{P} (3)

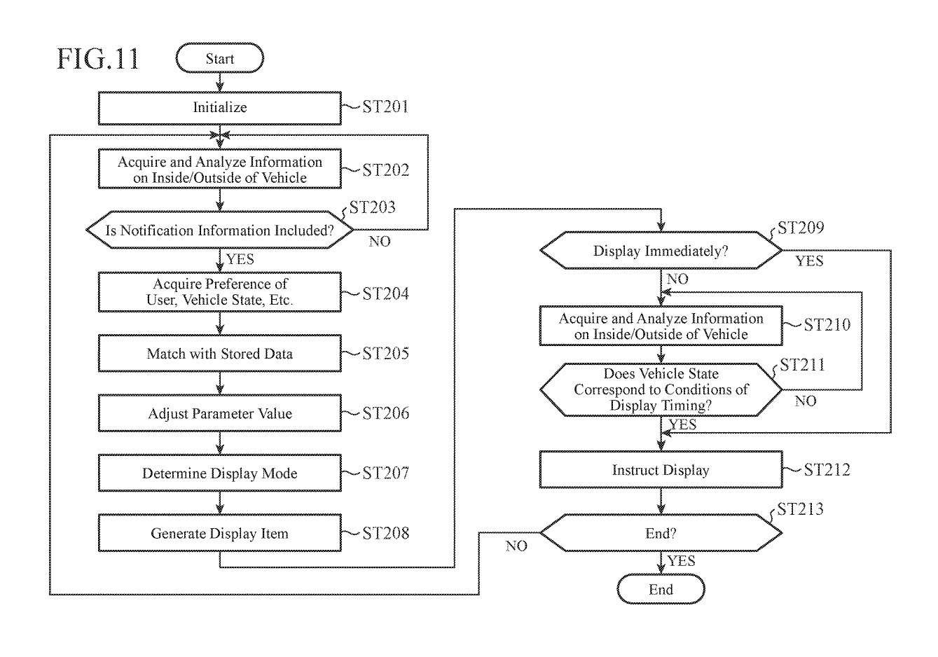

Next, operations of the display control device 1 of the second embodiment will be described using a flowchart in FIG. 11.

First, the display control device 1 performs initialization of the entire device when the engine is turned on or a function of the display control device 1 is turned on (step ST201).

Next, the information acquisition unit 2 acquires information of at least one of the inside of the vehicle (inside the moving body) or outside of the vehicle (outside the moving body) via the Internet or from the drive recorder 9, the camera 10, the ultrasonic sensor 11, the GPS 12, the CAN 13, the car navigation device 14, the smartphone 15, or the like. Thereafter, the information analysis unit 3 analyzes the information acquired by the information acquisition unit 2 to acquire notification information or the state of the vehicle (moving body) (step ST202).

When the notification information cannot be acquired (NO in step ST203), the flow returns to processing in step ST202. On the other hand, when the notification information can be acquired (YES in step ST203), the information analysis unit 3 analyzes the information acquired by the information acquisition unit 2 to acquire, as adjustment information for determining an adjustment value for each of the parameters corresponding to the notification information type (N), preference of the user, the state of the vehicle (moving body) or the like (step ST204).

Subsequently, the display determination unit 4 performs matching with the data stored in the information storage unit 5 and acquires, from the information storage unit 5, the respective parameters and image corresponding to the notification information type (N) acquired by the information analysis unit 3 (step ST205).

Thereafter, the display determination unit 4 determines the adjustment value of each of the parameters acquired in step ST205 using the adjustment information acquired by the information analysis unit 3 in step ST204 and thereby adjusts the respective parameter values (step ST206).

Then, the display mode of the notification information is determined based on each of the adjusted parameter values and image (step ST207).

Subsequent processing in steps ST208 to ST213 is the same as processing in steps ST106 to ST111 in the flowchart illustrated in FIG. 6 of the first embodiment and thus descriptions thereon are omitted.

The above described processing with reference to the flowchart will be described with a specific example below.

As illustrated by No. 2 in FIG. 7, for example, assuming that an e-mail where the sender is “Sato”, the title is “Change of meeting point”, and the body is “Please change today's meeting point from east exit to west exit of the station.” is received, the processing in steps ST201 to ST203 is performed. As a result, the information analysis unit 3 analyzes that the notification information has the notification information type (N) of “SNS” and includes additional information of the sender “Sato”, title “Change of meeting point”, and body “Please change today's meeting point from east exit to west exit of the station.”

Since the notification information type (N) is “SNS”, the information analysis unit 3 performs morphological analysis on the additional information and decomposes it into morphemes. Here, since the analysis result includes predefined keywords of “today” and “change”, these are acquired as adjustment information (keyword (K)). Moreover, it is assumed that “Sato” is acquired by acquiring a name registered as favorites from the car navigation device 14. Furthermore, by acquiring the vehicle speed, steering angle, and whether there is an approaching vehicle or not, it is assumed that the vehicle speed “0 km/h” (upon stopping), steering angle “0 degree”, and “absence” of approaching vehicle (step ST204) are acquired.

Next, the display determination unit 4 refers to the data stored in the information storage unit 5 as illustrated in FIG. 2 and acquires, as parameters corresponding to the notification information type (N) of “SNS”, a value of “1” for the relation with driving (D), value of “2” for the importance for the user (I), value of “1” for the immediacy of display (T), and balloon icon 21 (step ST205).

Note that, also in the second embodiment, the information storage unit 5 stores the data illustrated in FIG. 2 and the display determination unit 4 retains the data illustrated in FIGS. 4, 5, and 10. In addition, the threshold value for determining “relevant/not relevant” for each parameter is set at “2.5”.

Subsequently, the display determination unit 4 performs determination for the determination items defined in FIG. 10(a) to determine the adjustment value of each of the parameters and thereby adjusts the respective parameter values (step ST206).

Specifically, since the keywords acquired by the information analysis unit 3 include “today” and “change”, based on the keyword (K), the adjustment value for the immediacy (T) is determined as “+1”, and the adjustment value for the importance (I) is determined as “+1”.

Also, since the sender of the e-mail is “Sato” that corresponds to a name registered as favorites acquired by the information analysis unit 3, the adjustment value for the importance (I) based on preference (P) is determined as “+1”.

Determination is further made on the state of the vehicle (moving body) and the adjustment value based on the state of the vehicle (moving body) (C) is determined as “0” for any of the parameters.

Thereafter, the parameter values are adjusted with the parameter values before adjustment and the adjustment values based on the aforementioned formulas (1) to (3) (step ST206). Thus, the adjusted parameter values are calculated as in the following formulas (4) to (6).

D_{F}=1+0+0+0=1 (4)

I_{F}=2+1+0+1=4 (5)

T_{F}=2+1+0+0=3 (6)

After that, the display determination unit 4 determines the relation (D) as “not relevant” (x), the importance (I) as “relevant” (∘), and the immediacy (T) as “relevant” (∘), and refers to the table illustrated in FIG. 4to determine the display mode pattern as pattern 5. Moreover, the display timing is determined as “immediately” (step ST207).

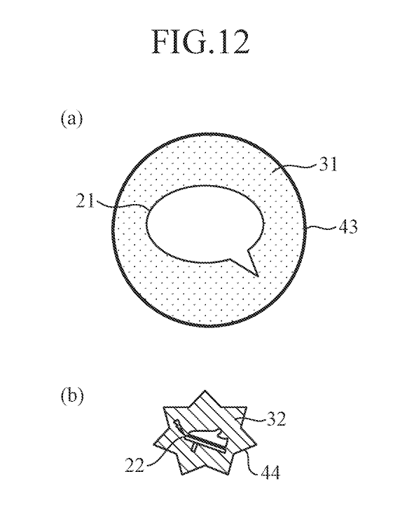

Thereafter, the display information generation unit 6 generates a display item based on the display information of the display mode determined by the display determination unit 4 (step ST208). That is, according to the display mode of pattern 5, since the background color is “blue”, size is “big”, and shape is “round”, and the amount of information is “small” so that the additional information is omitted from the display item, the display item is generated as illustrated in FIG. 12(a) where the background is the blue background 31 encircled in a big round frame 43 in which the balloon icon 21 is combined.

FIG. 12 shows diagrams illustrating examples of display items generated by the display information generation unit 6.

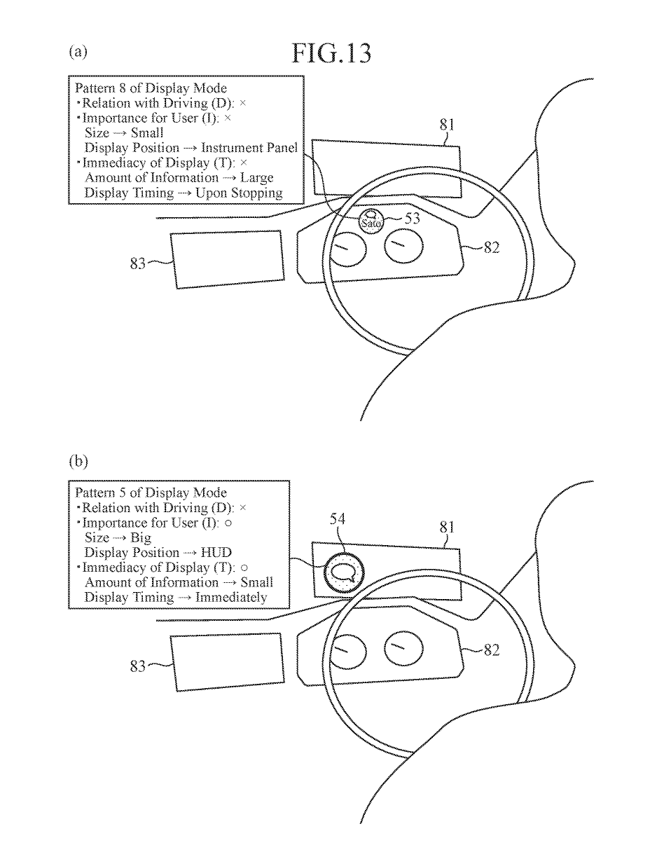

Since the display timing in this case is “immediately” (YES in step ST209), the display instruction unit 7 instructs to display the display item generated by the display information generation unit 6 as illustrated in FIG. 12(a) on the “HUD” (HUD 81) that is the display position determined by the display determination unit 4 (step ST212). As a result, for example as illustrated in FIG. 13(b), the display item 54 is displayed on the HUD 81.

FIG. 13 shows explanatory diagrams illustrating examples of display where the generated display item is displayed on the display device 8 (any one of the HUD 81, the instrument panel 82, and the center display 83). FIG. 13(a) illustrates that the display item 53 is displayed on the instrument panel 82 when no parameter adjustment is performed as in the first embodiment, and FIG. 13(b) illustrates that a display item 54 is displayed on the HUD 81 when the parameter adjustment of the second embodiment is performed.

In this manner, by using the adjustment information, the display mode pattern which is classified into pattern 8 in the first embodiment is classified into pattern 5 in the second embodiment. Consequently, since the information is determined to be important for the user, a big display item is displayed on the HUD 81 easily recognizable for the user, and since the information needs to be immediately notified to the user, the display item with a small amount of information is immediately displayed, thereby allowing for appropriate notification at a more appropriate timing.

Furthermore, as shown by No. 3 in FIG. 7 for example, the notification information type (N) of “sudden acceleration alert” with no additional information where the mode of sudden acceleration alert notification is set as “unimportant” will be described.

Here, the mode of sudden acceleration alert notification means the setting of whether the sudden acceleration alert notification is important or unimportant for a user in a case where such a setting can be preset. When the user prefers notification of the sudden acceleration alert, setting of “important” can be made and when the user does not require notification of the sudden acceleration alert, setting of “unimportant” can be made.

In this case, the respective parameter values acquired by the display determination unit 4 in step ST205 include the relation (D) of “4”, importance (I) of “3”, and immediacy (T) of “3”. Also, since the sudden acceleration alert notification is set as “unimportant”, FIG. 10(b) is referred to and the adjustment value of “−2” is obtained for the importance (I). As a result, calculating the adjusted parameter values based on the aforementioned formulas (1) to (3) results in the relation (D) of “4”, importance (I) of “1”, and immediacy (T) of “3” with the display mode pattern of pattern 3.

As a result, the display item is an image having the background color of “red”, size “small”, and shape “star”, that is, the display item is as illustrated in FIG. 12(b) where the background is the red background 32 encircled in a small star-shaped frame 44 in which the sudden acceleration icon 22 is combined. Moreover, display timing is “immediately” with the display position of “instrument panel” (instrument panel 82).

In this case, when parameter adjustment is not performed as in the first embodiment, the display mode pattern is pattern 1 with the display item having red background encircled in a big star-shaped frame in which the sudden acceleration icon 22 is combined as illustrated in FIG. 8(c) with display timing of “immediately” and the display position of “HUD” (HUD 81). However, due to the parameter adjustment of the second embodiment, the preference of the user is taking into account, and as a result, the display is changed to be in a small size on the instrument panel 82.

Other than the above, parameter adjustment using adjustment information is not performed for the notification information types (N) No. 4 to No. 6 in FIG. 7 of “fuel shortage alert”, “unsteady driving alert”, and “driving score” in this embodiment as described above and thus the classification results of display mode patterns do not vary from those of the first embodiment.

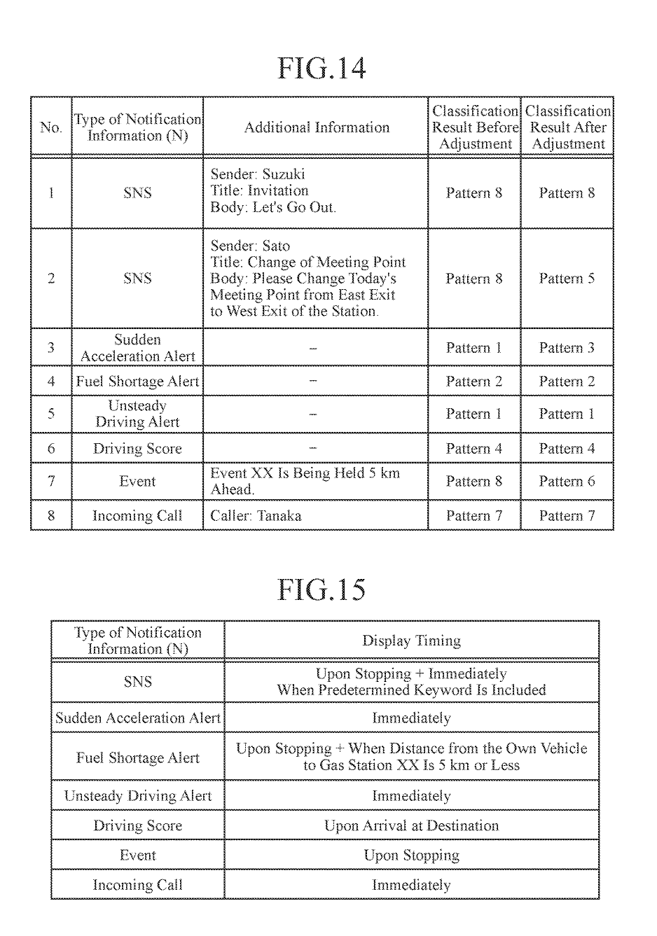

In other cases in FIG. 7, No. 1, or No. 7 and No. 8 where the notification information types (N) are “event” and “incoming call”, detailed descriptions with specific examples are omitted. As illustrated in FIG. 14, the display mode patterns are classified into pattern 8, pattern 6, and pattern 7, respectively, as a result of the parameter adjustment.

FIG. 14 is a table indicating notification information types (N) and additional information of the notification information which are analyzed by the information analysis unit 3, and a classification result, after performing adjustment of the second embodiment, of the specific example (FIG. 7) of display mode patterns corresponding thereto.

As described above, in the second embodiment, the display mode pattern to be selected is varied by adjusting parameter values for the importance for the user (I), immediacy of display (T) or the like, using adjustment information based on the information acquired by the information acquisition unit 2 or analysis result by the information analysis unit 3. Therefore, in addition to the effects in the first embodiment, the information can be notified to the user in a more appropriate display mode in accordance with the contents of the information, state of the user, or state of the moving body.

### Third Embodiment

A block diagram illustrating an example of a display control device and peripheral devices connected thereto according to a third embodiment of this invention is the same as FIG. 1 illustrated in the first embodiment and thus illustration thereof and description thereon are omitted. The third embodiment illustrated below is different as compared to the first embodiment in the point that the display timing of a display item is determined based on the information acquired by the information acquisition unit 2 and an analysis result thereof by the information analysis unit 3.

The information analysis unit 3 analyzes the information acquired by the information acquisition unit 2 and acquires notification information as well as information for determining display timing in accordance with the notification information type (N) (hereinafter referred to as “display timing determination information”).

For example, for the notification information type (N) of “fuel shortage alert”, operation history or the like acquired from the car navigation device 14 is analyzed to acquire positional information of gas stations frequently visited by the user or the like. That is, the display timing determination information in this case is the positional information of the gas station frequently visited by the user or the like.

Here, it is assumed that the display timing determination information to be acquired is defined for each of the notification information types (N). Moreover, not only the operation history but also navigation information, learned data, or the like may also be used.

The display determination unit 4 determines a display mode pattern of the notification information acquired by the information analysis unit 3 similarly to the case of the first embodiment. Thereafter, in a case where the display timing is “depending on the notification information type”, display timing is determined based on the display timing determination information and newly added as a display timing.

FIG. 15 is an example of a table defining display timing for each notification information type in a case where the display timing is “depending on the notification information type”, in which the display timing determination information is further taken into account, in the third embodiment.

As illustrated in FIG. 15, for example for the notification information type (N) of “SNS”, display timing is “upon stopping, or immediately when a predetermined keyword is included” where the display timing of “immediately when a predetermined keyword is included” is newly added to the case of the first embodiment illustrated in FIG. 5 with the display timing of only “upon stopping”.

In this case, the “a predetermined keyword” is a preset predetermined keyword that is considered preferable to be displayed immediately such as “change”. This predetermined keyword is the display timing determination information.

Also, for example for the notification information type (N) of “fuel shortage alert”, display timing is “upon stopping, or when the distance from the own vehicle to the gas station xx is 5 km or less”, where the display timing of “when the distance from the own vehicle to the gas station xx frequently visited by the user is 5 km or less” is newly added to the case of the first embodiment illustrated in FIG. 5 with the display timing of only “upon stopping”.

In this case, as described above, the display timing determination information is the positional information of the gas station xx frequently visited by the user, which can be acquired from the operation history or the like of the car navigation device 14.

This allows for notifying the information at a more appropriate timing by immediately displaying the fuel shortage alert considering preference of the user when the gas station xx frequently visited by the user is in the vicinity even though normally there is no need to immediately display the fuel shortage alert.

Note that, it is considered that the “gas station xx” in this case is not only one, but some samples exist in the operation history or the like of the car navigation device 14, so that the “gas station xx” is determined with dynamic change for being able to accept any of them.

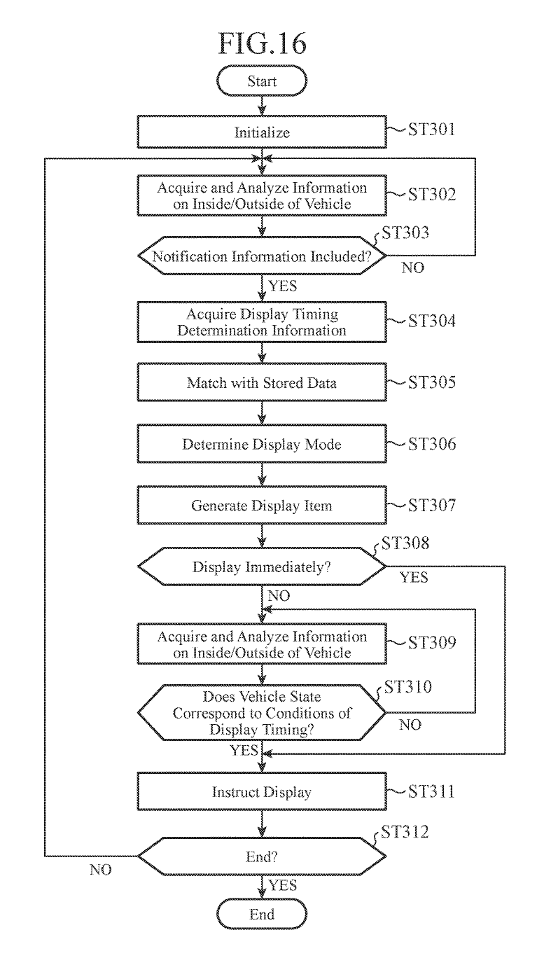

Next, operations of the display control device 1 of the third embodiment will be described using the flowchart in FIG. 16.

First, the display control device 1 performs initialization of the entire device when the engine is turned on or a function of the display control device 1 is turned on (step ST301).

Next, the information acquisition unit 2 acquires information of at least one of the inside of the vehicle (inside the moving body) or outside of the vehicle (outside the moving body) via the Internet or from the drive recorder 9, the camera 10, the ultrasonic sensor 11, the GPS 12, the CAN 13, the car navigation device 14, the smartphone 15, or the like. Thereafter, the information analysis unit 3 analyzes the information acquired by the information acquisition unit 2 to acquire notification information or the state of the vehicle (moving body) (step ST302).

When the notification information cannot be acquired (NO in step ST303), the flow returns to processing in step ST302. On the other hand, when the notification information can be acquired (YES in step ST303), the information analysis unit 3 analyzes the information acquired by the information acquisition unit 2 to acquire display timing determination information (step ST304).

The display determination unit 4 then performs matching with data stored in the information storage unit 5 and acquires, from the information storage unit 5, the respective parameters and image corresponding to the notification information type (N) acquired by the information analysis unit 3 (step ST305).

Thereafter, the display determination unit 4 determines the display mode of the notification information based on the respective parameter values and image. Here, when the display timing is “depending on the notification information type”, the display timing is determined based on the display timing determination information acquired in step ST304 (step ST306).

Subsequent processing in steps ST307 to ST312 is the same as processing in steps ST106 to ST111 in the flowchart illustrated in FIG. 6 of the first embodiment and thus descriptions thereon are omitted.

The above described processing with reference to the flowchart will be described with a specific example.

For example as illustrated by No. 4 in FIG. 7, an exemplary case of acquiring notification information with the notification information type (N) of “fuel shortage alert” is described.

Since the notification information type (N) is “fuel shortage alert”, the information analysis unit 3 analyzes operation history or the like acquired from the car navigation device 14 as the display timing determination information and thereby acquires positional information of a gas station frequently visited by the user.

Next, the display determination unit 4 refers to the data stored in the information storage unit 5 as illustrated in FIG. 2 and acquires, as parameters corresponding to the notification information type (N) of “fuel shortage alert”, the value of “4” for the relation with driving (D), value of “3” for the importance for the user (I), value of “2” for the immediacy of display (T), and refueling icon 23 (step ST305).

Here, also in the third embodiment, the information storage unit 5 stores the data illustrated in FIG. 2 while the display determination unit 4 retains the data illustrated in FIGS. 4 and 15. In addition, the threshold value for determining “relevant/not relevant” for each parameter is set at “2.5”.

Subsequently, the display determination unit 4 determines the relation (D) as “relevant” (∘), the importance (I) as “relevant” (∘), and the immediacy (T) as “not relevant” (x), and by referring to the table illustrated in FIG. 4, determines the display mode pattern as pattern 2. Here, since the display timing of pattern 2 is “depending on the notification information type”, “the distance from the own vehicle to the gas station xx (acquired position of the gas station xx) is 5 km or less” is added to the display timing based on the positional information of the gas station xx frequently visited by the user acquired by the information analysis unit 3 and the display mode is thereby determined (step ST306).

The display information generation unit 6 generates a display item based on the display mode determined by the display determination unit 4 (step ST307). That is, in accordance with the display mode of pattern 2, the display item is an image having the background color of “red”, size “big”, and shape “star”. Further, since the amount of information is “large”, the additional information is also displayed as the display item (however, there is no additional information in this case of “fuel shortage alert”). That is, the display item is generated as illustrated in FIG. 3(b) where the background is the red background 32 encircled in a big star-shaped frame 42 in which the refueling icon 23 is combined.

Then, since the display timing in this case is not “immediately” (NO in step ST308), the information analysis unit 3 analyzes the information of the inside/outside of the vehicle acquired by the information acquisition unit 2 (step ST309) and the display instruction unit 7 acquires the state of the vehicle (moving body) from the information analysis unit 3 and determines thereby whether the vehicle (moving body) satisfies any one of conditions of “upon stopping” and “when the distance from the own vehicle to the gas station xx is 5 km or less” or not (step ST310).

When one of the conditions is satisfied (YES in step ST310), the display instruction unit 7 instructs to display the display item generated by the display information generation unit 6 as illustrated in FIG. 3(b) on the “HUD” (HUD 81) that is the display position determined by the display determination unit 4 (step ST311).

In this manner, in the third embodiment, the display timing is determined by taking details of the received notification information, operation history of the user, or the like into account. Therefore, in addition to the effects in the first embodiment, the display information can be presented to the user in a more appropriate display timing in accordance with the contents of the display information, state of the user, or state of the moving body.

Note that, in the above third embodiment, descriptions have been provided on a case where the display timing of the display item is determined based on the information acquired by the information acquisition unit 2 or the analysis result thereof by the information analysis unit 3 in addition to the configuration and processing of the first embodiment. However, needless to say, in addition to the configuration and processing of the second embodiment, the display timing of a display item may be determined based on the information acquired by the information acquisition unit 2 or the analysis result thereof by the information analysis unit 3 through performing the processing of the aforementioned third embodiment.

Note that, within the scope of the present invention, the present invention may include a flexible combination of the respective embodiments, a modification of any component of the respective embodiments, or an omission of any component in the respective embodiments.

### INDUSTRIAL APPLICABILITY

The display control device of the invention can be applied to any apparatuses as long as the apparatus displays various information on a display device mounted on a moving body such as a vehicle. Such a device includes, for example, a display device such as a car navigation device, head-up display (HUD), or instrument panel, an apparatus having a display device, and an apparatus connected to a display device. Moreover, the display control device itself may be incorporated in such an apparatus. Moreover, the display control device may be applied to an application or the like installed in mobile information terminals such as smartphones, tablet PCs, and cellular phones.

### REFERENCE SIGNS LIST

1 display control device
2 information acquisition unit
3 information analysis unit
4 display determination unit
5 information storage unit
6 display information generation unit
7 display instruction unit
8 display device
9 drive recorder
10 camera
11 ultrasonic sensor
12 global positioning system (GPS)
13 controller area network (CAN)
14 car navigation device
15 smartphone
21 balloon icon
22 sudden acceleration ion
23 refueling icon
24 unsteady driving icon
25 score icon
26 event calendar icon
27 telephone icon
31 blue background
32 red background
41 small round frame
42 big star-shaped frame
43 big round frame
44 small star-shaped frame
51, 52, 53, 54 display item
81 head-up display (HUD)
82 instrument panel
83 center display

1. A display control device to instruct to display various information on a display device mounted on a moving body, the display control device comprising:
an information acquirer to acquire information of at least one of an inside of the moving body and an outside of the moving body;
an information analyzer to analyze the information acquired by the information acquirer to acquire notification information to be notified to a user and a state of the moving body;
an information storage to store at least two parameter values out of three parameters of: relation between the notification information and driving of the moving body; importance of the notification information for the user; and immediacy of the display of the notification information, and an image, which are associated with a type of the notification information;
a display determinator to acquire, from the information storage, the at least two parameter values and the image corresponding to the type of the notification information acquired by the information analyzer, and to determine a display mode including display information, a display timing, and a display position of the notification information based on the acquired at least two parameter values and the image;
a display information generator to generate a display item to be displayed on the display device based on the display information of the display mode determined by the display determinator; and
a display instructor to instruct to the display device to display the display item generated by the display information generator in accordance with the display mode determined by the display determinator.

2. The display control device according to claim 1,
wherein the display determinator classifies the display mode of the notification information into a plurality of predetermined display mode patterns in accordance with the at least two parameter values.

3. The display control device according to claim 2,
wherein the display determinator adjusts a parameter value for the importance for the user based on information acquired by the information acquirer or an analysis result from the information analyzer.

4. The display control device according to claim 2,
wherein the display determinator adjusts a parameter value for the immediacy of the display based on information acquired by the information acquirer or an analysis result from the information analyzer.

5. The display control device according to claim 1,
wherein the display instructor instructs to display the display item when the state of the moving body matches with conditions of display timing of the display mode determined by the display determinator.

6. The display control device according to claim 1,
wherein the information analyzer analyzes the information acquired by the information acquirer and acquires display timing determination information for determining the display timing in addition to the notification information to be notified to the user and the state of the moving body, and
the display determinator determines the display timing based on the display timing determination information acquired by the information analyzer.

7. The display control device according to claim 1,
wherein the display information generator generates the display item by synthesizing display materials respectively corresponding to the relation with driving, the importance for the user, and the immediacy of the display.

8. The display control device according to claim 7,
wherein the display material corresponding to the immediacy of the display represents an amount of the display information.

9. A display control method to instruct to display various information on a display device mounted on a moving body, the display control method comprising:
acquiring, by an information acquirer, information of at least one of an inside of the moving body and an outside of the moving body;
analyzing, by an information analyzer, the information acquired by the information acquirer to acquire notification information to be notified to a user and a state of the moving body;
acquiring, by a display determinator, from an information storage storing at least two parameter values, out of three parameters of: relation between the notification information and driving of the moving body; importance of the notification information for the user; and
immediacy of the display of the notification information, and an image which are associated with a type of the notification information, the at least two parameter values and the image corresponding to the type of the notification information acquired by the information analyzer and determining a display mode including display information, display timing, and a display position of the notification information based on the acquired at least two parameter values and image;
generating, by a display information generator, a display item to be displayed on the display device based on the display information of the display mode determined by the display determinator; and
instructing, by a display instructor, to the display device to display the display item generated by the display information generator in accordance with the display mode determined by the display determinator.

10. A non-transitory computer-readable medium comprising instructions that, when executed by a processor, cause the processor to perform the following method:
acquiring, by an information acquirer, information of at least one of an inside of the moving body and an outside of the moving body;
analyzing, by an information analyzer, the information acquired by the information acquirer to acquire notification information to be notified to a user and a state of the moving body;
acquiring, by a display determinator, from an information storage storing at least two parameter values, out of three parameters of: relation between the notification information and driving of the moving body; importance of the notification information for the user; and
immediacy of the display of the notification information, and an image which are associated with a type of the notification information, the at least two parameter values and the image corresponding to the type of the notification information acquired by the information analyzer and determining a display mode including display information, display timing, and a display position of the notification information based on the acquired at least two parameter values and image;
generating, by a display information generator, a display item to be displayed on the display device based on the display information of the display mode determined by the display determinator; and
instructing, by a display instructor, to the display device to display the display item generated by the display information generator in accordance with the display mode determined by the display determinator.
